(19) United States
(12) Patent Application Publication
(10) Pub. No.: US 2024/0169852 A1
(43) Pub. Date: May 23, 2024

(54) METHOD AND APPRATUS FOR CHEMISTRY EDUCATION

(71) Applicant: 101 Edu, Inc., New York, NY (US)

(72) Inventors: Justin Weinberg, New York, NY (US); Igor Belyayev, New York, NY (US); Amanda Kutney, Atlanta, GA (US); Sazzad Hossain, Jamaica, NY (US)

(21) Appl. No.: 17/991,649

(22) Filed: Nov. 21, 2022

(51) Int. Cl. G09B 5/06; G09B 19/00

(52) U.S. Cl. CPC G09B 5/06; G09B 19/00

(57) ABSTRACT

A system includes a first chemical structure, a plurality of selectable start indicators, a plurality of selectable endpoint indicators, a first electron-pushing arrow, and an accuracy indicator. The first chemical structure includes at least one of a first chemical structure atomic bond indicator, a first chemical structure atom indicator, a first chemical structure lone pair indicator, and a first chemical structure functional group indicator. Each representation of the first chemical structure atomic bond indicator and each representation of an atom having the first chemical structure lone pair indicator includes a selectable start indicator. The first electron-pushing arrow includes a first tail associated with a location of one of the selectable start indicators and a first head associated with a location of one of the selectable endpoint indicators. The accuracy indicator indicates whether there was proper placement of electron-pushing arrow(s).

### FIELD OF TECHNOLOGY

An improved chemistry education system and method is disclosed. Improvements are applicable to the field of chemistry education.

### BACKGROUND

In the field of chemistry education, computer applications that allow users to digitally “draw” chemical structures or mechanistic aspects thereof are often employed. These applications may provide a problem for the user (e.g., a student) to solve, as well as provide general-purpose drawing tools for the user to employ while attempting to solve the problem.

One problem or task often encountered in organic chemistry education is the task of drawing one or more electron-pushing arrows on one or more chemical structures. Electron-pushing arrows drawn on chemical structure(s) illustrate the movement of electrons (electron density) as bonds between atoms are broken or formed. Additionally, electron-pushing arrows may be employed to illustrate the distribution of positive and negative charges around organic molecules through resonance. Further, electron-pushing arrows may even be employed in inorganic chemistry examples.

Chemistry education applications, however, may offer little to no guidance to the user as the user navigates the task of drawing one or more electron-pushing arrows. That is, the application may simply provide the user drawing tools to create the arrows, but provide little guidance to the user as the user digitally draws the arrow(s). Since guidance may be lacking, the rate at which the user learns electron-pushing arrow drawing techniques may be slowed, thus increasing user frustration.

Thus, there is a need for chemistry education systems and applications that maximize a user's learning potential while at the same time minimizing user frustration as electron-pushing arrow drawing techniques are learned.

### BRIEF DESCRIPTION OF THE DRAWINGS

FIG. 1 illustrates an exemplary chemistry education application and/or system operating on an exemplary computing device;

FIGS. 2A-2K illustrate exemplary operations of a system or apparatus for creating one or more electron-pushing arrows; and

FIG. 3 illustrates an exemplary technique to aid a user in making one or more electron-pushing arrows.

### DETAILED DESCRIPTION

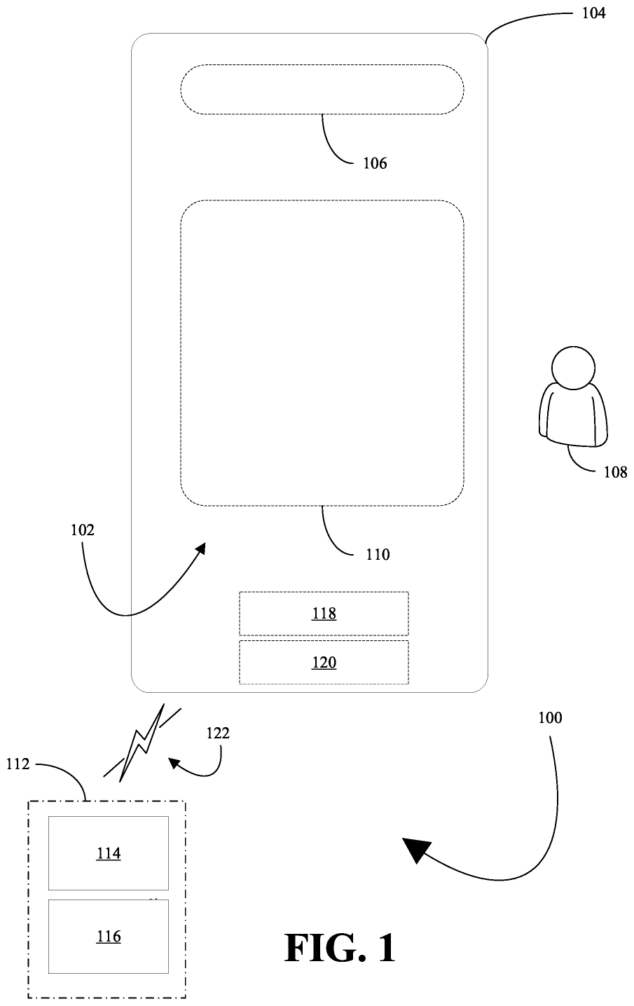

FIG. 1A illustrates an exemplary chemistry education system 100. The chemistry education system 100 includes an exemplary chemistry education application 102 operating on a front-end system (e.g., a smart phone, computer tablet, personal computer, or etc.) 104. As will be discussed in further detail below, the chemistry application 102 presents an exemplary chemistry problem or directive 106 to a user 108 and provides an exemplary workspace 110 for the user 108 to solve the chemistry problem 106. The workspace 110 represents an area where the user 108 may carry out tasks in an attempt to properly solve the problem 106. While FIG. 1 represents the problem 106 and the workspace 110 being presented together, other examples may present the problem 106 at a different time than the workspace 110. Further, in other examples, the placement and size of both the workspace 110 and the problem 106 may be different than those shown.

The chemistry education system 100 may also include a back-end or remote system 112. The back-end system 112 may, for example, be employed to carry out intensive computational tasks for the chemistry application 102. This back-end system 112 may, for example, be an offsite or geographically remote compute system or systems such as a cloud compute system.

To carry out computational tasks, the back-end system 112 may include a memory 114 and at least one central processing unit (CPU) 116. Similarly, the front-end system 104 may also include a memory 118 and at least one CPU 120 to carry out computational tasks. Communication between the front-end system 104 and the back-end system 112 may be carried out over a network 122.

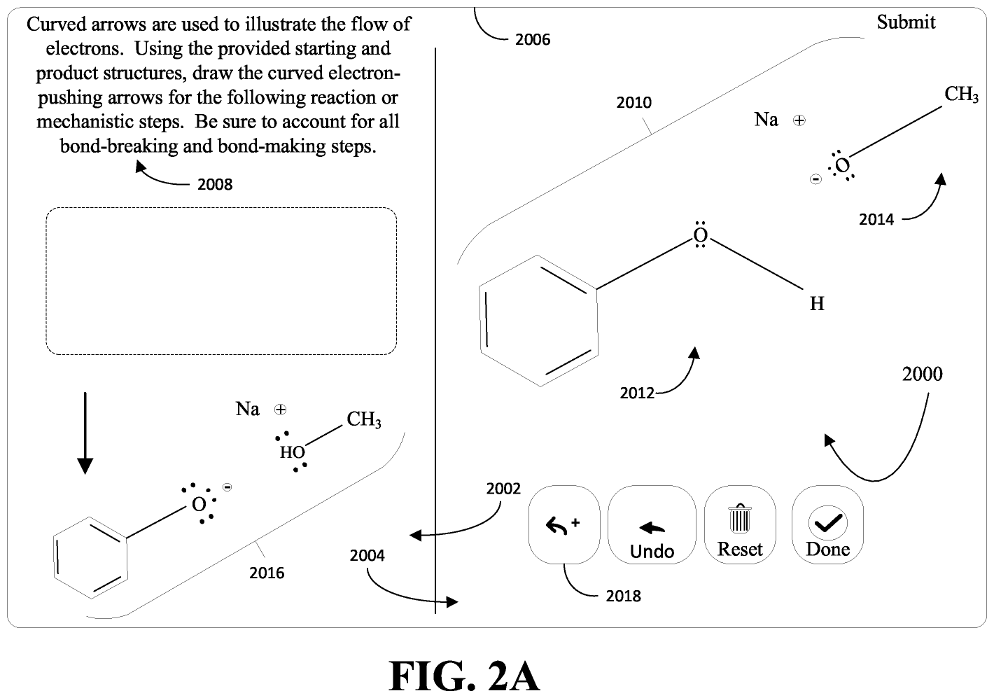

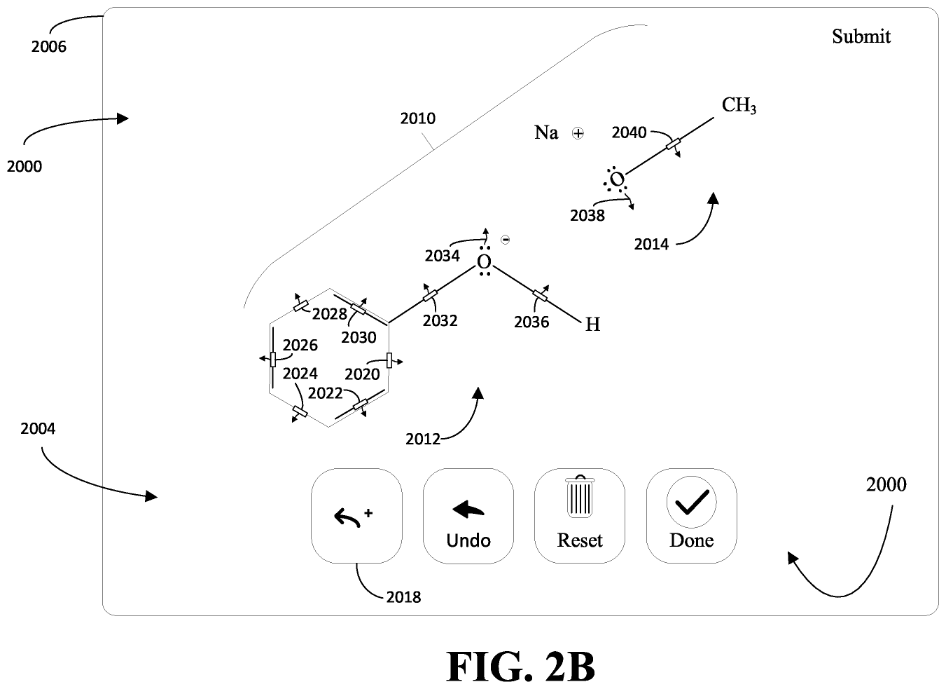

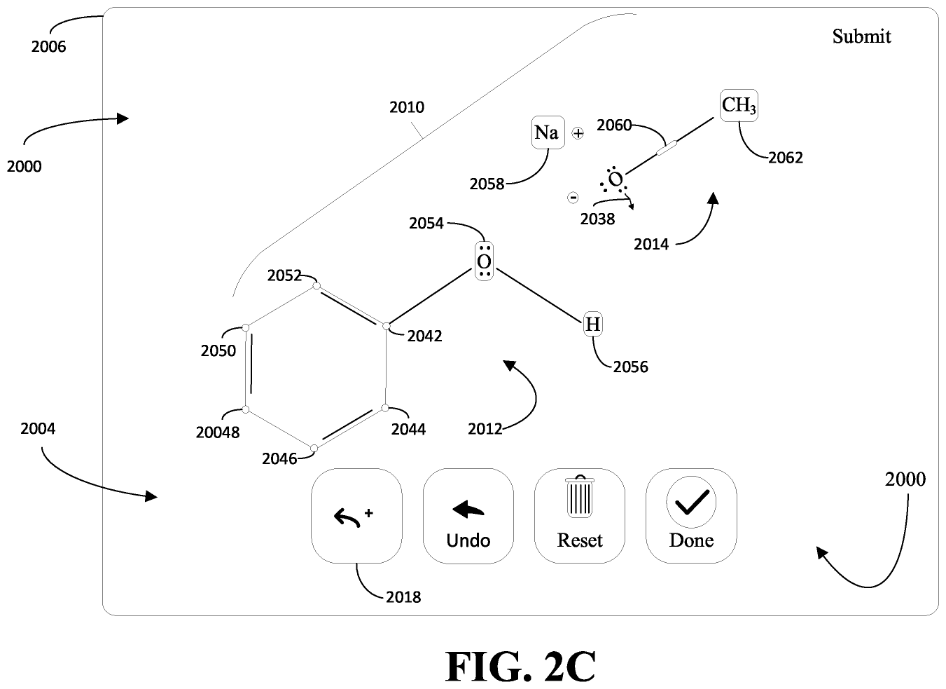

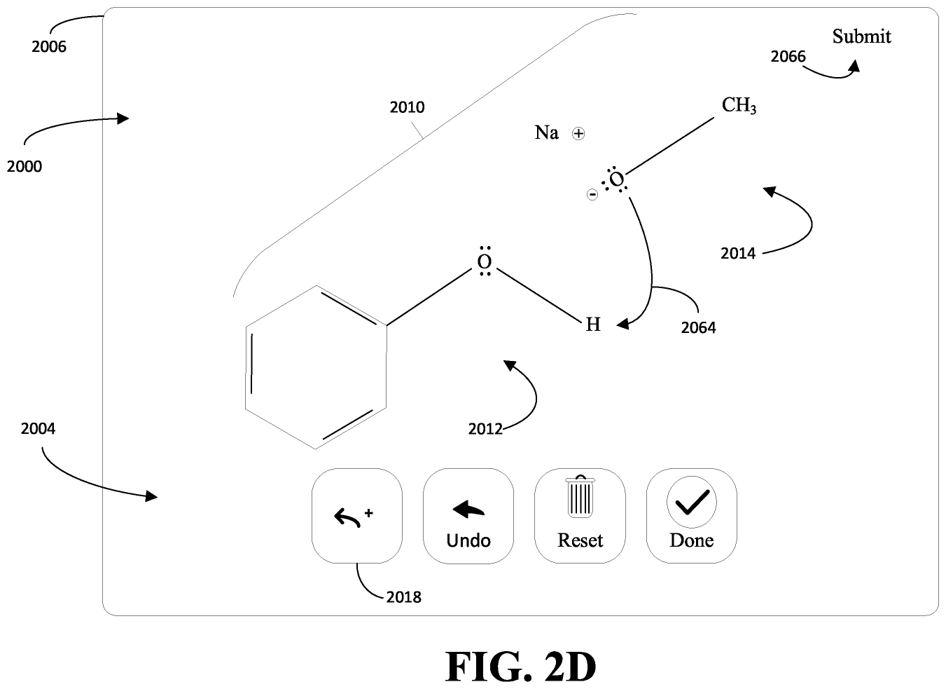

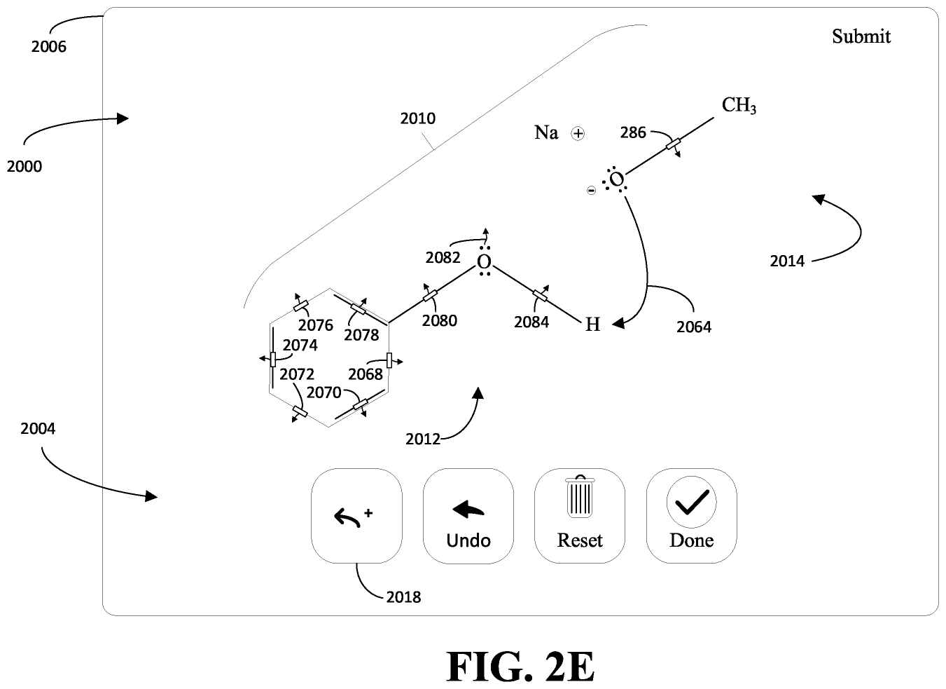

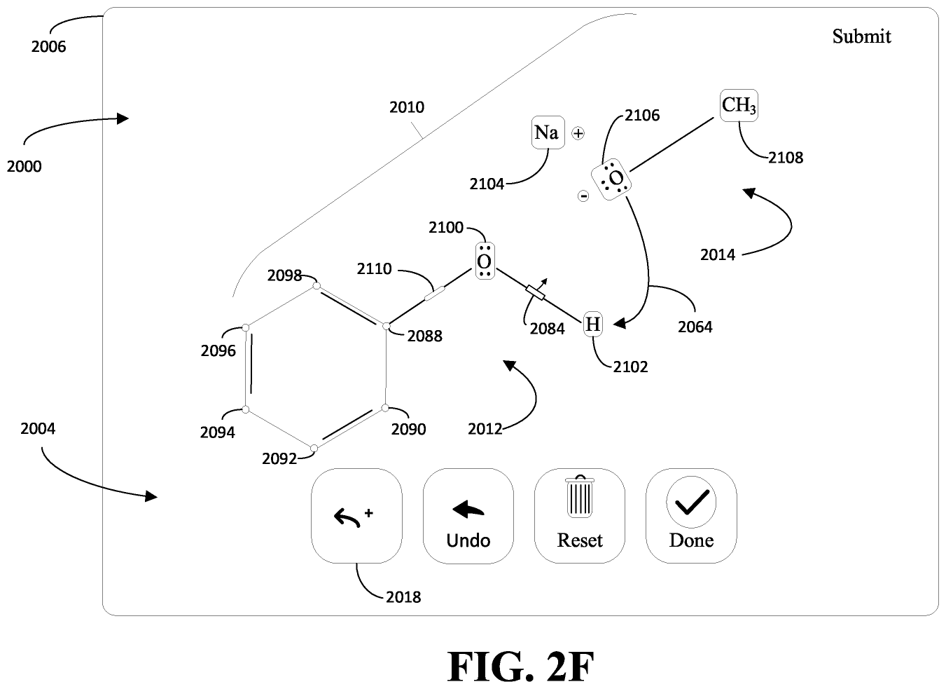

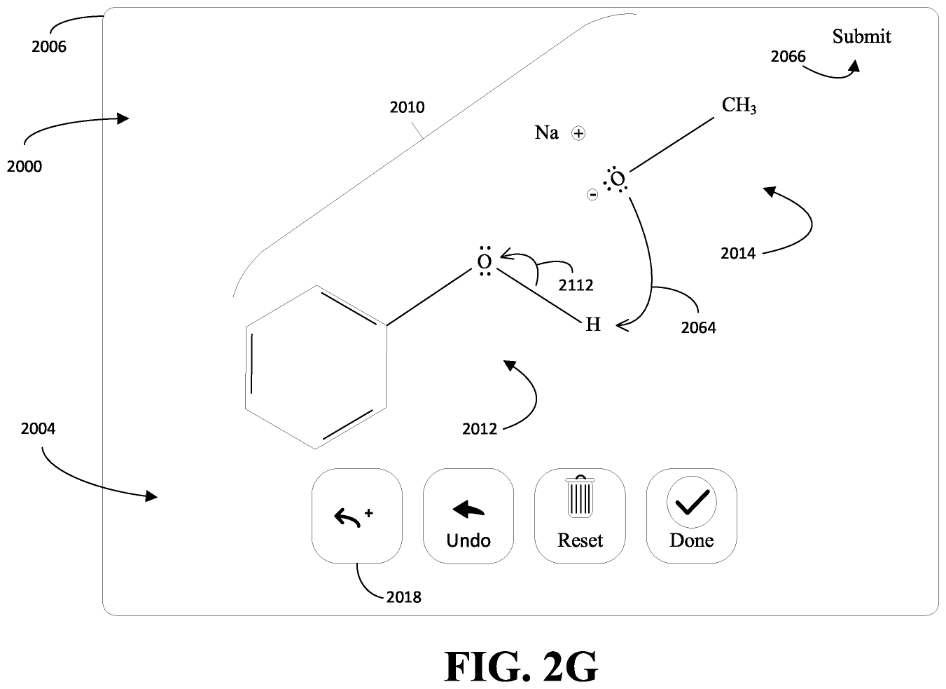

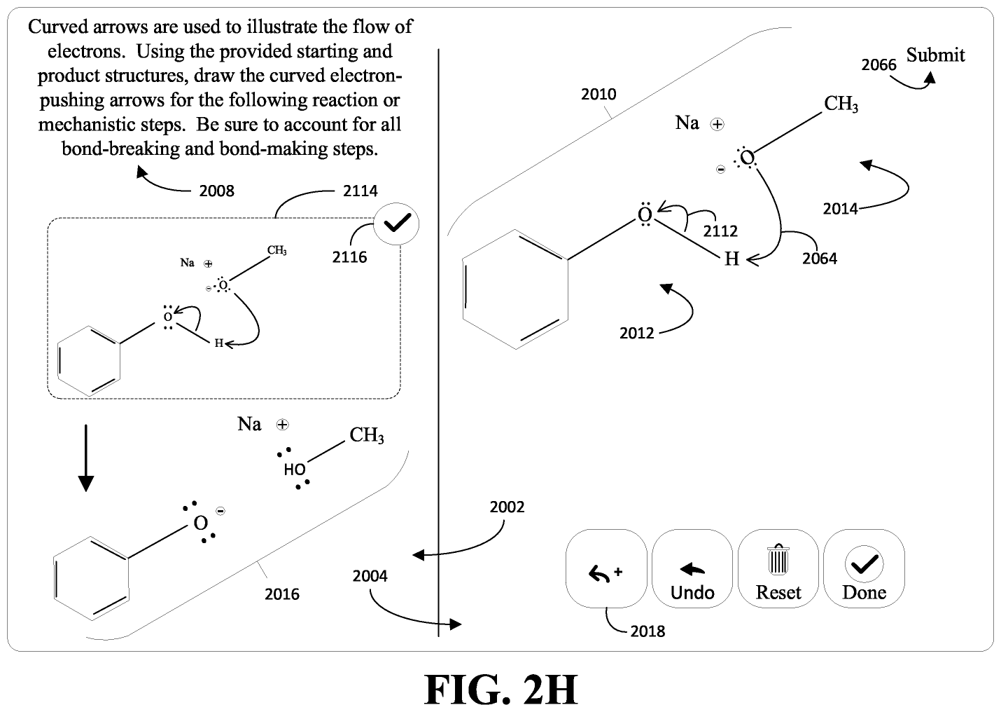

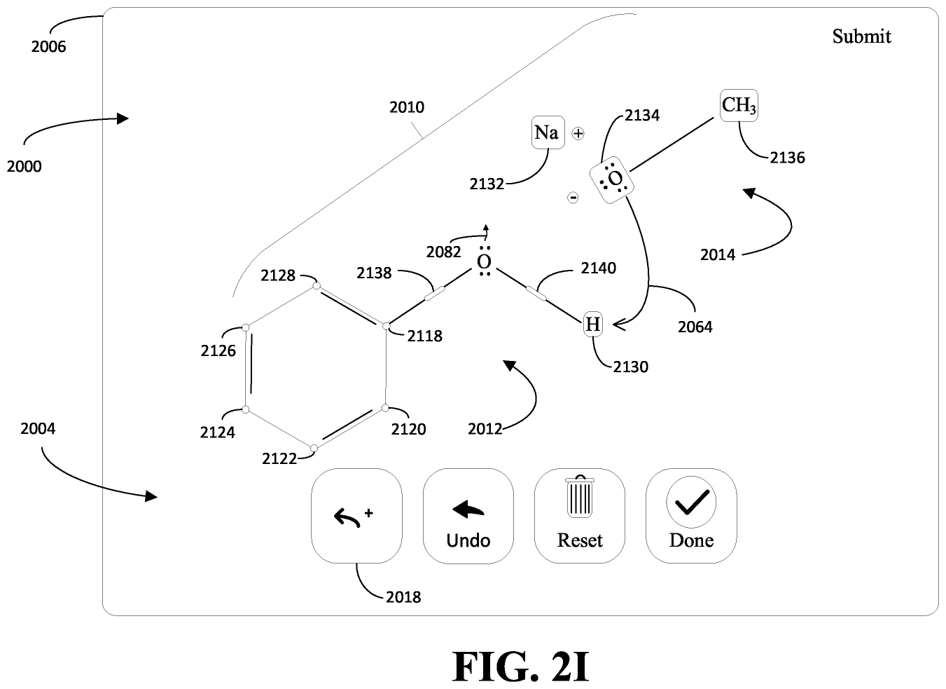

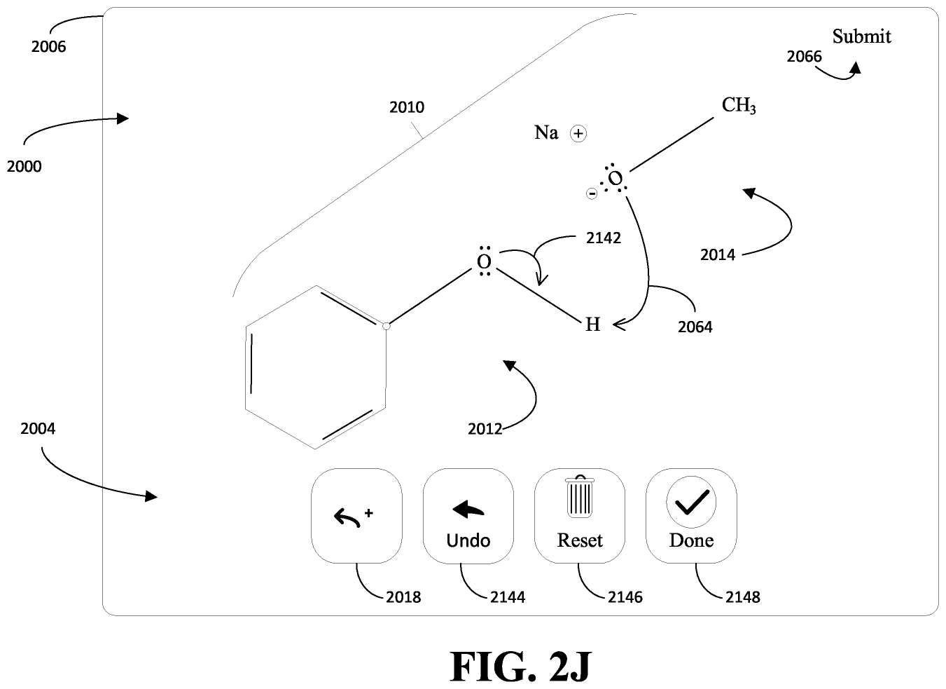

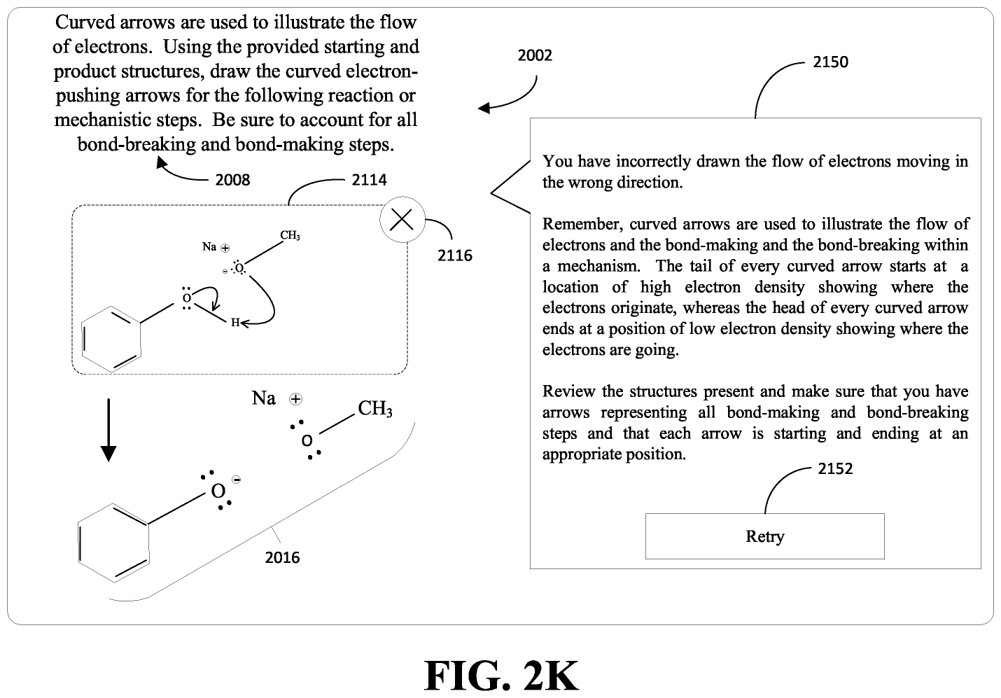

With reference now to FIGS. 2A-2K, exemplary operations of a chemistry education system, apparatus, or application 2000 is shown.

As illustrated in FIG. 2A, the chemistry education application or system 2000 may present a directive side 2002 and a work-space side 2004 on a display 2006 of a user device (e.g., the front-end system 104 of FIG. 1). The directive side 2002 presents an exemplary problem or directive 2008 to the user (e.g., the user 108 of FIG. 1). In the example shown, the problem states the following: “Curved arrows are used to illustrate the flow of electrons. Using the provided starting and product structures, draw the curved electron-pushing arrows for the following reaction or mechanistic steps. Be sure to account for all bond-breaking and bond-making steps.” Other examples, however, may pose different problems or directives. For example, the user may be directed to use electron-pushing arrow(s) to illustrate or describe the phenomenon of resonance in a single chemical structure. Nonetheless, with reference to the exemplary directive shown 2008, “starting” structures and “product” structures are referenced.

Exemplary “starting” structures 2010 (referenced in the directive 2008) shown in FIG. 2A include a first exemplary starting chemical structure 2012 and a second exemplary starting chemical structure 2014 presented on the work-space side 2004 of the display 2006. On the directive side 2002 of the display 2006, “product” structure(s) 2016 (referenced in the directive 2008) are shown.

While the examples discussed with respect to FIGS. 2A-2K illustrate two starting structures 2012, 2014, other examples may present additional starting structures. Further, still other examples may include only one starting chemical structure. For example, if the user is directed to describe the phenomenon of resonance, the user may be given a single starting structure and a resonant product structure. That is, the chemistry application 2000 may provide resonant structures (e.g., a single starting structure and a resonant product structure) to the user. As will be described below in further detail, the user may then draw one or more electron-pushing arrows on the starting structure to illustrate aspects of resonance.

With reference back to FIG. 2A, the work-space side 2004 presents the starting structures 2010 that will react with each other to create the product structures 2016 shown on the directive side 2002. As presented by the directive 2008, the user's task is to properly show the electron-pushing arrow(s) on the starting structures 2010 during the reaction that yields the product structure(s) 2016. Electron-pushing arrows represent movement of electrons (electron density) during a reaction.

The type and amount of product structures 2016 and starting structures 2010 presented in FIG. 2A are merely exemplary. One or more other product structures may instead be employed. As such, one or more different starting structures may also be employed. Further, sets of product structures may be presented to represent a chain of reactions, where selection of each product structure may cause a unique set of starting structures to be presented.

With reference back to the example presented in FIG. 2A, a first chemical structure (e.g., the first chemical structure 2012 of FIG. 2A) can include at least one of a first chemical structure atomic bond indicator, a first chemical structure atom indicator, a first chemical structure lone pair indicator, and a first chemical structure functional group indicator. Similarly, a second chemical structure (e.g., the second chemical structure 2014 of FIG. 2A) can include at least one of a second chemical structure atomic bond indicator, a second chemical structure atom indicator, a second chemical structure lone pair indicator, and a second chemical structure functional group indicator.

With reference to FIG. 2A, by engaging (e.g., tapping, mouse click, or etc.) with an exemplary electron-pushing icon 2018, the chemistry application 2000 allows the user to begin creating electron-pushing arrow(s). FIG. 2B represents a moment after the user engaged with the electron-pushing icon 2018 of FIG. 2A. The example illustrated in FIG. 2B presents the work-space side 2004 on the display 2006, but does not present the directive side 2002 of FIG. 2A and the details thereof on the display 2006. Other examples, however, may instead present both the directive side 2002 and the work-space side 2004 on the display 2006.

As shown in FIG. 2B, after engaging with the electron-pushing icon 2018, the chemistry application 2000 identifies locations for possible start indicators and causes a plurality of potential start indicators 2020-2040 to be presented on the display 2006 at those identified locations. The chemistry application 2000 identifies locations by determining the locations of each bond (see, e.g., chemical structure atomic bond indicators of the starting structures 2010) and each lone pair (see, e.g., the lone pair indicators on the oxygen atoms of the starting structures 2010) in the starting structures (e.g., the first and second starting structures of FIG. 2B).

As will be discussed in further detail below, the potential start indicators 2020-2040 are selectable and represent potential electron-pushing arrow starting points to the user. That is, the user may select any one of the potential start indicators 2020-2040 (a.k.a., selectable start indicators) to serve as a start point for an electron-pushing arrow. The visual representation of the start indicators 2020-2040 are merely exemplary. Other exemplary start indicators may employ different visual representations. Since only the bond locations and each atom with one or more lone pairs available include a selectable start indicator 2020-2040, the user is offered some guidance. That is, since only the bond locations and each atom with at least one lone pair include a selectable start indicator 2020-2040, the user learns at least that electron-pushing arrows do not start on atoms without a lone pair.

According to the example illustrated in FIG. 2B, there are selectable start indicators 2020-2030, 2036, 2040 presented on each bond (i.e., bond indicator) and there are selectable start indicators 2034, 2036 presented on each atom with an available lone pair. Other chemical structure(s), however, may have a different amount of bonds and/or available lone pairs. As such, other examples may include a different amount of start indicators than those shown in FIG. 2B.

While each of the start indicators (e.g., start indicators 2020-2040 of FIG. 2B) are selectable by a user, each does not necessarily represent a valid starting point for an electron-pushing arrow. As such, the chemistry application 2000 allows the user to make mistakes so that the user is engaged with the learning process. Nonetheless, though the user is allowed to make mistakes, starting indicators are not presented on every atom or atom grouping. For example, the carbon atoms of the carbon ring of the first chemical structure 2012, the hydrogen atom (H) of the first chemical structure 2012, and the CH₃ functional group of the second chemical structure 2014 do not include starting indicators since each does not include an available lone pair. By avoiding the presentation of selectable starting points at these invalid locations, the user is guided through the problem solving process and becomes aware that electron-pushing arrows do not begin at atoms or functional groups without an available lone pair.

As discussed above, each starting indicator 2020-2040 is selectable by the user. Once a start indicator is selected, the other start indicators (i.e., unselected start indicators) will disappear. For example, if the user selects the start indicator 2038 on an available lone pair of the oxygen (O) atom of the second exemplary starting structure 2014 as the starting point for an electron-pushing arrow, the remaining (unselected) start indicators (2020-2036, 2040) disappear as shown in FIG. 2C, leaving only the selected start indicator 2038. In other words, all potential or selectable start indicators 2020-2036, 2040, except for the selected start indicator 2038, disappear.

Once a start indicator is selected (e.g., the selected start indicator 2038 of FIG. 2C), the system (e.g. chemistry application 2000) automatically identifies locations for a plurality of potential endpoint indicators (a.k.a. selectable endpoint indicators) and places a potential endpoint indicator at each identified location. The selectable endpoint indicators are possible endpoints for an electron-pushing arrow that will begin at the selected start point (e.g., the selected start indicator 2038 of FIG. 2C). Similar to the manner in which selectable start indicators are presented, selectable endpoint indicators are not placed at all locations on the starting chemical structures. Rather, the chemistry application identifies i) any bond adjacent to the selected start indicator within the same chemical structure as the selected start indicator (e.g., the first chemical structure 2012 or the second chemical structure 201) and ii) any atom or functional group (e.g., CH₃) among the starting structure(s) that does not correspond with the starting point or location thereof. As such, none of the potential endpoint indicators are associated with the start selection (e.g., the start selection 2038 of FIG. 2C) or location thereof. Upon identification, the chemistry application places the selectable starting points at the identified locations.

Accordingly, and with continued reference to FIG. 2C, since the start point/start indicator 2038 has been selected, the chemistry application 2000 identifies endpoint locations and places a plurality of selectable endpoint indicators 2042-2062 at the identified locations on the display 2006. As shown in FIG. 2C, the bond adjacent to the selected start indicator 2038 on the second chemical structure 2014 includes a selectable endpoint indicator 2060, each atom (e.g., carbon, oxygen, hydrogen, and sodium) among the starting structures 2010 includes a selectable endpoint indicator 2042-2058, and the functional group (i.e., the CH₃ methyl group) includes a selectable endpoint indicator 2062. It is understood that the selectable endpoint indicators 2042-2052 on the carbon ring are associated with carbon atoms. The oxygen atom (0) associated with the selected starting point 2038 does not include a selectable endpoint since this the location of the selected starting point 2038.

These selectable endpoint indicators 2042-2062 are automatically presented on the display 2006 to the user after the user selects the starting point 2038. With regard to the bonds, and as discussed above and shown in FIG. 2C, not all bonds include a selectable endpoint. Rather, only the bond(s) adjacent to the selected starting point, and within the same chemical structure as the selected starting point, include a selectable endpoint. Accordingly, in the example shown in FIG. 2C, only the bond between the oxygen (O) and the functional group (CH₃) includes a selectable endpoint 2060 since that bond is adjacent to the selected starting point 2038. As such, the user learns at least that an electron-pushing arrow will not end on a bond of a chemical structure that does not include the selected starting point.

As mentioned above, the selectable endpoints 2042-2062 are possible endpoints for an electron-pushing arrow that will begin at the selected start point 2038. Like the selectable starting points 2020-2040 of FIG. 2B, the selectable endpoints 2042-2062 of FIG. 2C do not necessarily represent valid endpoints for an electron-pushing arrow that begins at the selected starting point (i.e., the selected starting point 2038 on the second exemplary starting structure 2014).

Once an endpoint is selected by the user, an electron-pushing arrow will be created between the start location and the endpoint location. For example, if the user selects the endpoint indicator 2056 associated with the hydrogen (H) atom of the first starting structure 2012, the possible endpoints 2042-2062 may disappear and an electron pushing arrow 2064 will be created as shown in FIG. 2D. That is, an electron-pushing arrow 2064 that starts, or includes a tail, at or near the location of previously selected start indicator (FIG. 2C) and ends, or includes a head, at or near the location of the selected endpoint indicator 2056 (FIG. 2C) is created. As shown in FIG. 2D, the selected start indicator 2038 may also disappear when the electron-pushing arrow is created. It is noted that the visual representation of the electron-pushing arrow 2064 of FIG. 2D is merely exemplary. As such, other visual representations of electron-pushing arrows may instead be employed.

To further engage the user, the creation of the electron-pushing arrow 2064 may be animated such that it appears to grow from the selected start indicator 2038 (FIG. 2C) to the selected endpoint 2056 (FIG. 2C), thus dynamically conveying the flow of electrons that the electron-pushing arrow 2064 represents.

Once the electron-pushing arrow 2064 has been created, the user is allowed to, among other things, continue by once again engaging with the electron-pushing arrow icon 2018 or submit their answer by engaging with a submit icon 2066. If the user once again engages with the electron-pushing arrow icon 2018, another plurality of selectable start indicators 2068-2086 will be presented to the user as shown in FIG. 2E.

As mentioned above, selectable start indicators will appear at any bond or atom with at least one available lone pair. As such, according the the example shown in FIG. 2E, the nine bonds or bond indicators have selectable start indicators 2068-2080, 2084, 2086 and the oxygen atom of the first starting structure 2012 having the available lone pair includes a potential or selectable start indicator 2082.

As also mentioned above, electron-pushing arrows of FIGS. 2A-2K represent aspects of a chemical reaction in progress. As such, the electron pushing arrow 2064 of FIG. 2E indicates that there is no longer an available lone pair on the oxygen atom (0) of the second starting structure 2014. As such, the chemistry application 2000 does not place a selectable starting indicator on the oxygen atom of the second exemplary structure 2014.

FIG. 2F indicates that the user has selected the start indicator 2084 associated with the bond between the oxygen (O) and hydrogen (H) atoms on the first starting structure 2012. As such, the remaining starting indicators 2068-2082, 2086 of FIG. 2E have disappeared and are not shown in FIG. 2F. The user is now able to select an endpoint for the selected starting point 2084. As previously discussed, each atom, grouping of atoms, or bond(s) adjacent to the selected starting point within the same chemical structure as the selected starting point (i.e., the first chemical structure 2012 in this example) will be user selectable as an endpoint. As such, the example presented in FIG. 2F illustrates the ten atoms include selectable end points 2088-2106, one methyl atom-grouping include a selectable endpoint 2108, and the bond between the carbon atom and the oxygen atom of the first starting structure 2012 that is adjacent to the selected starting point 2084 includes a selectable endpoint 2110. When identifying bonds adjacent to the selected start indicator (e.g., the selected start indicator 2084 of FIG. 2F), the chemistry application 2000 looks at bonds on the chemical structure associated with the selected start indicator. For example, since the selected start indicator 2084 of FIG. 2F is on the first chemical structure 2012, the chemistry application 2000 looks for adjacent bonds on the first chemical structure 2012 and not on the second chemical structure 2014.

While the first chemical structure 2012 includes only one bond adjacent (see endpoint indicator 2110) to the selected start indicator 2084, other examples may have more than one bond adjacent to the selected start indicator. For example, with reference back to FIG. 2E, if the bond (see the location indicator 2080) between the oxygen atom and the carbon atom of the first chemical structure 2012 was instead selected as a starting point, then three bonds would include selectable endpoints since three bonds would be adjacent to the selected starting point. That is, in addition to other selectable endpoints, the bonds at indicators 2078, 2068, and 2084 would each include a selectable endpoint since they are considered adjacent to the exemplary starting point (i.e., the bond found at the location of indicator 2080).

With reference back to FIG. 2F, if the user selects, for example, the selectable endpoint 2100 associated with the oxygen atom (O) of the first structure 2012, the chemistry application 2000 will create another electron-pushing arrow 2112 on the display 2006 as shown in FIG. 2G, and the selected starting point 2106 and selectable endpoints 2088-2110 of FIG. 2F will disappear from the display 2006.

There are many configurations electron-pushing arrows may take. For example, though not shown, it will be appreciated that a user may create arrows such that the tail of one electron-pushing arrow may begin at the head of another electron-pushing arrow or the head of one electron-pushing arrow ends at the head of another electron-pushing arrow. As will be described below, the chemistry application will determine the accuracy of the user's configurations.

With reference back to FIG. 2G, if the user feels he or she has solved the directive 2008 (FIG. 2A), the user may engage with a “submit” icon 2066. FIG. 2H represents an exemplary scenario after the user engaged with the submit icon 2066 during the scenario represented in FIG. 2G. As shown in the example illustrated in FIG. 2H, after the user engages with the submit icon 2066, the starting structures (e.g., 2012, 2014) with each electron-pushing arrow (e.g., 2064, 2112) created by the user may appear in a submitted answer window 2114. Further, the user will be notified whether or not their submitted answer is correct via an accuracy indicator 2116. That is, the accuracy indicator indicates whether there was proper placement of the electron-pushing arrow and any additional electron-pushing arrows that may be present. In the example shown in FIG. 2H, the accuracy indicator 2116 notifies the user that the submitted answer is correct.

There are, however, examples where the user may have not have properly placed or oriented the electron-pushing arrow(s). For example, with reference back to FIG. 2E, the user has already created the first electron pushing arrow 2064 between the oxygen atom of the second starting structure 2014 and the hydrogen atom of the first starting structure 2012. If the user instead selected the start indicator 2082 on the oxygen lone pair of the first starting structure 2012 as the starting point for a second electron-pushing arrow, the scenario presented in FIG. 2I would occur. That is, a plurality of selectable endpoints 2118-2134 will appear on each atom not associated with the selected starting point 2082 of the lone pair on the oxygen atom, a selectable endpoint 2136 will appear on each atom grouping (e.g., CH₃), and a selectable endpoint 2138, 2140 will appear on each bond of the first chemical structure 2012 that is adjacent to the selected starting point 2082. Since there are two bonds adjacent to the selected starting point 2082, selectable endpoints 2138, 2140 appear on each bond.

As an alternate example, if the double covalent bond between locations 2128 and 2118 on the carbon ring of FIG. 2I instead included a selected start indicator, the following bonds would include a selectable endpoint indicator: the single covalent between locations 2126 and 2128; the single covalent bond between locations 2118 and 2120; and the single covalent bond between locations 2118 and 2082. In this example, though not shown, these bonds would include selectable endpoint indicators since they are adjacent to the selected start indicator and within the same chemical structure 2012 thereof.

Similarly, if the carbon atom associated with location 2118 instead included a selected start indicator, there would be three bonds adjacent to the selected start indicator. As such, there are examples where more than one bond is adjacent to the selected start indicator.

With reference back to the example illustrated in FIG. 2I, if the user selects the endpoint indicator 2140 on the bond coupling the oxygen atom (O) and the hydrogen atom (O) of the first starting structure 2012, the chemistry application 2000 creates another electron-pushing arrow 2142 on the display 2006 as shown in FIG. 2J.

The user may continue interaction by, for example, engaging with the electron-pushing icon 2018 to begin creating another electron-pushing arrow, an undo icon 2144 that would undo the last act (e.g., the creation of the second electron-pushing arrow 344), a reset icon 2146 that would start the problem over, or an exit icon 2148 that would exit the problem.

An artisan will appreciate that this electron-pushing arrow 2142 starting on the oxygen atom (O) of the first starting structure 2012 and ending on the bond coupling the oxygen (O) and the hydrogen (H) of the first chemical structure 2012 is not accurate. As such, if the user engages with the submit icon 2066, the chemistry application 2000 will notify the user that the answer is wrong as shown in FIG. 2K via the accuracy indicator 2116. Only the directive side 2002 of the chemistry application 2000 is shown on the display 2006 in FIG. 2K. Other examples, however, may also present the working-space side 2004 (e.g., the working-space side 2004 of FIG. 2I) along with the directive side 2002.

As shown in FIG. 2K, the accuracy indicator 2116 notifies the user that the submitted answer (shown in the submitted answer window 2114) is wrong. Further, the chemistry application 2000 may provide the user feedback, as represented in an exemplary feedback window 2150. As shown with the exemplary feedback presented in the feedback window 2150, the feedback window 2150 may provide the user some guidance or hints for properly answering the directive 2008. If desired, the user may, for example, engage with an exemplary “Retry” icon 2152 to once again attempt to properly address the directive 2008.

As set forth above with respect to FIGS. 2A-K, the chemistry application 2000 allows the user to create one or more electron-pushing arrows in an efficient and intuitive manner. Further, since the chemistry application 2000 allows the user to make mistakes (see e.g., the second electron-pushing arrow 2142 of FIG. 2J), the user is actively engaged and challenged in the learning process, thus increasing the user's ability to retain and implement proper techniques employed in creating electron-pushing arrows.

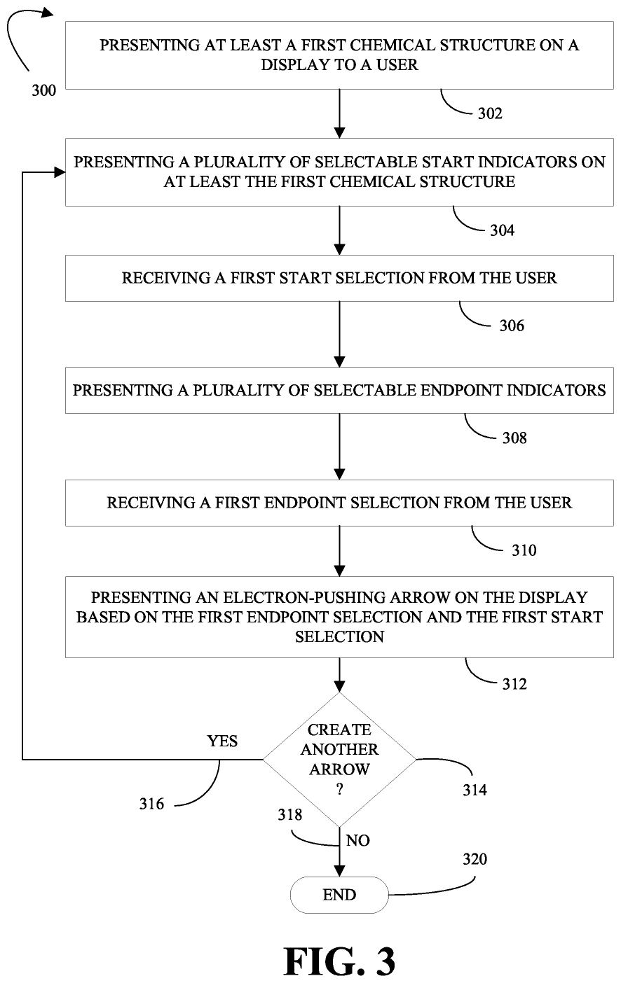

With reference now to FIG. 3, a technique 300 for creating one or more electron-pushing arrows is shown. Process control begins at block 302, where presenting at least a first chemical structure on a display to a user is set forth. Process control then proceeds to block 304, where presenting a plurality of selectable start indicators on the at least first chemical structure is carried out. Process control may carry out the placement of the selectable start indicators by first identifying locations of each atomic bond (e.g., each single, double, and/or triple atomic bond) and each available lone pair (e.g., the lone pairs 2034, 2038 of FIG. 2B) that may be represented on the at least first chemical structure. Once the locations are identified they may be presented on the display to the user. If additional chemical structure(s) (e.g. a second chemical structure) are presented at block 302, then process control will identify and locate selectable starting points on the additional chemical structure(s) as well.

Selectable start indicators are, as the name implies, user selectable and each represent potential starting points for an electron-pushing arrow. For example, see the plurality of selectable start indicators 2020-2040 presented on the chemical structures 2012, 2014 by the chemistry application 2000 on the display 2006 of FIG. 2B. Each of the selectable start indicators represents a location of a possible tail or starting point for an electron-pushing arrow.

With reference back to FIG. 3, after presenting the plurality of selectable start indicators, process control proceeds to block 306 for receiving a first start selection (e.g., the start selection 2038 of FIG. 2C) from the user. The first start selection represents a user selection of one of the indicators of the plurality of selectable start indicators. As discussed above with respect to FIG. 2C, after the start selection is made by the user, the remainder of the unselected selectable start indicators disappear. That is, the unselected start indicators are no longer presented on the display after the start selection.

Upon receiving the first start selection, process control carries out presenting a plurality of selectable endpoint indicators on the at least first chemical structure at block 308. Each selectable endpoint indicator represents a possible location of the head (a.k.a. endpoint) of the electron-pushing arrow. Process control may carry out the presentation of the selectable endpoint indicators by first identifying (locating) each atom, grouping of atoms, and each atomic bond adjacent to the start selection that are represented on the chemical structure(s). Any bond of a chemical structure that includes the selected starting point will not include a selectable endpoint. That is only adjacent bonds within the chemical structure that includes the selected starting point will include a selectable endpoint indicator, in addition to each atom and grouping of atoms.

Once the locations of the selectable endpoint indicators are identified, process control may present the selectable endpoint indicators at the identified locations on the display. For example, as represented in FIG. 2D the following exemplary selectable end indicators are shown: selectable endpoint indicators 2042-2052 on each carbon atom; a selectable endpoint indicator 2054 on the oxygen atom (O) of the first exemplary chemical structure 2012; a selectable endpoint indicator 2058 on the sodium atom (Na), a selectable endpoint indicator 2062 on the methyl atom-grouping (CH₃); and a selectable endpoint indicator 2060 on the bond adjacent to the start selection 2038 associated with the lone pair on the oxygen atom of the second chemical structure 2014.

With reference back to FIG. 3, after the selectable endpoint indicators are presented on the display, receiving a first endpoint selection from the user is carried out by process control at block 310. As discussed above with respect to FIG. 2D, after the endpoint selection is made by the user, the endpoint indicators disappear prior to creation of the electron-pushing arrow.

Upon receiving the end selection from the user, process control carries out presenting an electron-pushing arrow on the display based on the first endpoint selection and the first start selection at block 312. In other words, process control creates the electron-pushing arrow such that the tail of the arrow begins at the start selection and the head of the arrow ends at the endpoint selection. Presentation of the electron-pushing arrow may be animated to further convey motion. For example, process control may present the electron-pushing arrow as growing from the start selection and stopping at the endpoint selection. Other exemplary animations may also be employed. For example, the electron-pushing arrow may be presented with a color gradient along the arrow that implies motion from the starting point to the ending point.

At decision block 314, process control determines if the user intends to create another electron-pushing arrow. Such a determination may be based on a user input. For example, the user may engage with an electron-pushing arrow icon 2018 such as that shown in FIG. 2J to indicate to process control that the user intends to create another electron-pushing arrow. Alternatively, the user may, for example, engage with the “submit” icon 2148 (see FIG. 2J) to indicate to process control that the user does not intend to create another electron pushing arrow.

Referring back to FIG. 3, if process control determines that the user intends to create another electron-pushing arrow 316, process control proceeds back to block 304 and another plurality of selectable start indicators are presented on at least first chemical structure, and technique 300 continues.

On the other hand, if process control determines that the user will not be creating 318 another electron-pushing arrow, process control may proceed to an end 320.

With reference now back to FIGS. 1-3 discussed above, exemplary system(s) and devices may be any computing system and/or device that includes a processor (e.g., CPU 116, 120 of FIG. 1) and a memory (e.g., memory 114, 118). Computing systems and/or devices generally include computer-executable instructions (e.g., chemistry education application 200 of FIGS. 2A-2K), where the instructions may be executable by one or more computing devices such as those listed above and below. Computer-executable instructions may be compiled or interpreted from computer programs created using a variety of programming languages and/or technologies, including, without limitation, and either alone or in combination, Java™, C, C++, Visual Basic, Java Script, Perl, etc. The exemplary system(s), device(s), and items therein may take many different forms and include multiple and/or alternate components. While exemplary systems, devices, and modules are shown in the Figures, the exemplary components illustrated in the Figures are not intended to be limiting. Indeed, additional or alternative components and/or implementations may be used, and thus the above examples should not be construed as limiting.

In general, computing systems and/or devices may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OS X and iOS operating systems distributed by Apple Inc. of Cupertino, California, the BlackBerry OS distributed by Research In Motion of Waterloo, Canada, and the Android operating system developed by the Open Handset Alliance. Examples of computing systems and/or devices include, without limitation, personal computers, cell phones, smart-phones, super-phones, tablet computers, next generation portable devices, handheld computers, secure voice communication equipment, or some other computing system and/or device.

Further, the processor or the microprocessor (e.g., CPUs 116, 120) of computing systems and/or devices receives instructions from the memory (e.g., memory 114, 118) and executes these instructions, thereby performing one or more processes, including one or more of the processes described herein. Such instructions and other data may be stored and transmitted using a variety of computer-readable mediums (e.g., memory 118).

A CPU or processor may include processes comprised from any hardware, software, or combination of hardware or software that carries out instructions of a computer programs by performing logical and arithmetical calculations, such as adding or subtracting two or more numbers, comparing numbers, or jumping to a different part of the instructions. For example, the CPUs 116, 120 of FIG. 1 may be any one of, but not limited to single, dual, triple, or quad core processors (on one single chip), graphics processing units, visual processing units, and virtual processors.

Memory (e.g., memory 114, 118) may be, in general, any computer-readable medium (also referred to as a processor-readable medium) that may include any non-transitory (e.g., tangible) medium that participates in providing data (e.g., instructions) that may be read by a computer (e.g., by CPU 120 of exemplary mobile device 104). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including radio waves, metal wire, fiber optics, and the like, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With further regard to FIGS. 1-3 and the processes, systems, methods, techniques, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of terms such as “first,” “second,” “third,” and the like that immediately precede an element(s) do not necessarily indicate sequence unless set forth otherwise, either explicitly or inferred through context.

1. A system comprising:
a first chemical structure comprising at least one of a first chemical structure atomic bond indicator, a first chemical structure atom indicator, a first chemical structure lone pair indicator, and a first chemical structure functional group indicator;
a plurality of selectable start indicators such that a selectable start indicator is respectively associated with each representation of the first chemical structure atomic bond indicator and each representation of an atom having the first chemical structure lone pair indicator;
a plurality of selectable endpoint indicators;
a first electron-pushing arrow having i) a first arrow tail associated with a first user start selection and ii) a first arrow head associated with a first user endpoint selection, wherein the first user start selection corresponds with one selectable start indicator of the plurality of selectable start indicators, and wherein the first user endpoint selection corresponds with one selectable endpoint indicator of the plurality of selectable endpoint indicators; and
an accuracy indicator to indicate whether there was proper placement of the first electron-pushing arrow and any additional electron-pushing arrows.

2. The system of claim 1 further comprising a hint that provides guidance to a user when the accuracy indicator indicates there was not proper placement of at least one of the electron-pushing arrow and the any additional electron-pushing arrows.

3. The system of claim 1 further comprising a product structure, wherein the first chemical structure and the product structure represent resonance structures.

4. The system of claim 1 further comprising:
a second chemical structure comprising at least one of a second chemical structure atomic bond indicator, a second chemical structure atom indicator, a second chemical structure lone pair indicator, and a second chemical structure functional group indicator, wherein each representation of the second chemical structure atomic bond indicator and each representation of an atom in the second chemical structure having the second chemical structure lone pair indicator is associated with a respective selectable start indicator from the plurality of selectable start indicators; and
a first chemical product structure, wherein the first chemical product structure represents a chemical reaction between the first chemical structure and the second chemical structure.

5. The system of claim 4 wherein there is not a selectable endpoint indicator of the plurality of selectable endpoint indicators associated with a location of the first user start selection.

6. The system of claim 5 wherein a selectable endpoint indicator of the plurality of selectable endpoint indicators is respectively associated with each representation of i) an atom of the first chemical structure, ii) an atom of the second chemical structure; iii) a functional group of the first chemical structure, iii) a functional group of the second chemical structure, and ii) each bond adjacent to the first user start selection.

7. The system of claim 6 further comprising a plurality of additional selectable start indicators, wherein each location of each additional selectable start indicator of the plurality of additional selectable start indicators does not correspond with a location of the first user start selection.

8. The system of claim 6 further comprising:
a plurality of additional selectable endpoint indicators on at least one of the first chemical structure and the second chemical structure; and
a second electron-pushing arrow having i) a second arrow tail associated with a location of one the additional selectable start indicators of the plurality of selectable start indicators and ii) a second arrow head associated with a location of one of the additional selectable endpoint indicators of the plurality of additional selectable endpoint indicators.

9. A method carried out by at least one hardware processor, the method comprising:
presenting at least a first chemical structure and a second chemical structure on a display to a user;
presenting a plurality of selectable start indicators on at least the first chemical structure such that a selectable start indicator is presented on each bond and each atom having an available lone pair that may be present on the first chemical structure, wherein each selectable start indicator of the plurality of selectable start indicators is selectable by the user;
receiving a first start selection from the user, wherein the first start selection represents user selection of one of the selectable start indicators of the plurality of selectable start indicators on the display, and wherein the first start selection represents a start point of a first electron-pushing arrow indicator;
receiving a first endpoint selection from the user, wherein the first endpoint selection represents user selection of an endpoint on the display for the first electron-pushing arrow; and
presenting the first electron-pushing arrow on the display to the user based on the first endpoint selection and the first start selection.

10. The method of claim 9 further comprising presenting a product chemical structure, wherein the first chemical structure and the product structure are resonance structures.

11. The method of claim 9 further comprising:
presenting a product chemical structure to the user;
presenting a second chemical structure to the user, wherein the product chemical structure represents a chemical reaction between the first chemical structure and the second chemical structure, and wherein a selectable start indicator of the plurality of selectable start indicators is presented on each bond of the second chemical structure and on any atom of the second chemical structure having a lone pair;
removing each selectable start indicator of the plurality of selectable start indicators from the display that does not correspond with the first start selection after the first start selection is made; and
presenting a plurality of selectable endpoint indicators on at least one of the first and second chemical structures, wherein each selectable endpoint indicator of the plurality of selectable endpoint indicators is selectable by the user and represents a selectable endpoint for the first electron-pushing arrow, and wherein the first endpoint selection represents user selection of one of the selectable endpoint indicators of the plurality of selectable endpoint indicators on the display.

12. The method of claim 11 wherein each bond adjacent to the first start selection includes one of the selectable endpoint indicators of the plurality of selectable endpoint indicators, each atom represented on the at least first and second chemical structures includes one of the selectable endpoint indicators of the plurality of selectable endpoint indicators, and each atom grouping represented on the at least first and second chemical structures includes one of the selectable endpoint indicators of the plurality of selectable endpoint indicators.

13. The method of claim 9 further comprising presenting a second plurality of selectable start indicators on the display after presenting the first electron-pushing arrow, wherein one of the selectable start indicators of the second plurality of selectable start indicators will represent a location of a start point of a second electron-pushing arrow.

14. The method of claim 13 further comprising presenting a second plurality of selectable endpoint indicators on the display, wherein one of the selectable endpoint indicators of the second plurality of selectable endpoint indicators will represent a location of an endpoint of the second electron-pushing arrow.

15. A non-transitory computer-readable medium storing instructions executable by a hardware processor to:
present at least a first chemical structure on a display to a user;
identify a plurality of selectable start locations on at least the first chemical structure where the user may place a tail end of a first electron-pushing arrow;
present a selectable start indicator at each identified location of the plurality of selectable start locations such that a plurality of selectable start indicators is presented on the display;
receive a start selection from the user, wherein the start selection represents user selection of one of the selectable start indicators of the plurality of selectable start indicators, and wherein the start selection represents a location of the tail end of the first electron-pushing arrow;
identify a plurality of selectable endpoint locations on at least the first chemical structure based on the start selection;
receive an endpoint selection from the user, wherein the endpoint selection corresponds with one selectable endpoint location of the plurality of selectable endpoint locations, and wherein the endpoint selection will represent a head of the first electron pushing arrow; and
present the first electron pushing arrow on the display to the user based on the start selection and the endpoint selection.

16. The non-transitory computer-readable medium of claim 15 storing further instructions executable by the hardware processor to present a product chemical structure on the display to the user, wherein the first chemical structure and the product chemical structure are resonant chemical structures.

17. The non-transitory computer-readable medium of claim 15 storing further instructions executable by the hardware processor to:
present a product chemical structure on the display to the user; and
present a second chemical structure on the display to the user, wherein the product chemical structure represents a chemical reaction between the first and second chemical structures, and wherein i) each atom and atom group represented in any of the first and second chemical structures is identified as one of the selectable start locations of the plurality of selectable start locations and ii) each bond represented in any of the first and second chemical structures is identified as one of the selectable start locations of the plurality of selectable start locations.

18. The non-transitory computer-readable medium of claim 17 wherein i) each atom and atom group represented in any of the first and second chemical structures that does not correspond with the first start selection is identified as one of the selectable endpoint locations of the plurality of selectable endpoint locations and ii) each bond in one of the first chemical structure and the second chemical structure that is adjacent to the start selection is identified as one of the possible endpoint locations of the plurality of selectable endpoint locations.

19. The non-transitory computer-readable medium of claim 15 storing further instructions executable by a hardware processor to remove, after the first start selection, each selectable start indicator of the plurality of selectable start indicators from the display that does not correspond with the first start selection.

20. The non-transitory computer-readable medium of claim 15 storing further instructions executable by a hardware processor to present a selectable endpoint indicator at each identified endpoint location.
